(19) United States
(12) Patent Application Publication
(10) Pub. No.: US 2025/0382127 A1
(43) Pub. Date: Dec. 18, 2025

(54) Trash Can Lid-Securing Device

(71) Applicant: Jennifer Riggs, Las Vegas, NV (US)

(72) Inventor: Jennifer Riggs, Las Vegas, NV (US)

(21) Appl. No.: 19/201,437

(22) Filed: May 7, 2025

Related U.S. Application Data
(60) Provisional application No. 63/659,368, filed on Jun. 13, 2024.

(51) Int. Cl. B65F 1/16

(52) U.S. Cl. CPC B65F 1/1615; B65F 2210/148

(57) ABSTRACT

A trash can lid-securing device is provided. The device is designed to prevent unauthorized or accidental opening of a trash can lid by employing a locking body comprising a vertical frame member and at least two horizontal members that engage both the trash can lid and body. The vertical frame member may be either fixed or telescopic, with integrated locking mechanisms and an optional sliding interface for vertical repositioning of components to accommodate various trash can geometries. Grip structures on the horizontal members further enhance secure attachment in one embodiment. The device may also be comprised of adhesive anchors affixed to the lid to provide a locking interface for the upper horizontal member.

### CROSS-REFERENCE TO RELATED APPLICATION

The present application claims priority to, and the benefit of, U.S. Provisional Application No. 63/659,368, which was filed on Jun. 13, 2024, and is incorporated herein by reference in its entirety.

### FIELD OF THE INVENTION

The present invention relates generally to the field of trash can lids. More specifically, the present invention relates to a device designed to prevent unauthorized or accidental opening of a trash can lid by employing a locking body comprising a vertical frame member and at least two horizontal members that engage both the trash can lid and body. Accordingly, the present disclosure makes specific reference thereto. Nonetheless, it is to be appreciated that aspects of the present invention are also equally applicable to other like applications, devices, and methods of manufacture.

### BACKGROUND

Outdoor trash cans are commonly used by residential and commercial users to temporarily store waste until it is collected by municipal or private waste management services. These receptacles typically rely on simple, hinged lids that are not secured in a locked position. As a result, the lids are frequently opened unintentionally due to environmental factors such as wind or by small animals seeking access to food waste. This leads to trash being scattered across private property and public spaces, contributing to widespread litter. The litter not only causes unsightly conditions but may also present hazards to local ecosystems and wildlife. Despite the availability of various receptacle designs, most lack integrated mechanisms to effectively secure the lid against forced entry. Current solutions are often size-specific, difficult to install, or not sufficiently weather-resistant for outdoor use.

Therefore, there exists a long-felt need in the art for a trash can lid-securing device that prevents wind from opening trash receptacle lids and dispersing waste. There also exists a long-felt need in the art for a trash can lid-securing device that deters small animals from accessing and scattering the contents of trash cans. Moreover, there exists a long-felt need in the art for a trash can lid-securing device that universally adapts to various receptacle sizes and shapes used by different waste management services.

The subject matter disclosed and claimed herein, in one embodiment thereof, comprises a trash can lid-securing device. The device is designed to prevent unauthorized or accidental opening of a trash can lid by employing a locking body comprising a vertical frame member and at least two horizontal members that engage both the trash can lid and body. The vertical frame member may be either fixed or telescopic, with integrated locking mechanisms and an optional sliding interface for vertical repositioning of components to accommodate various trash can geometries. Grip structures on the horizontal members further enhance secure attachment in one embodiment. The device may also be comprised of adhesive anchors affixed to the lid to provide a locking interface for the upper horizontal member.

In this manner, the trash can lid-securing device of the present invention accomplishes all the foregoing objectives and provides a device that secures the lid of a trash can. The inclusion of a telescoping vertical member and/or repositionable components enables adaptability to a variety of receptacle geometries and dimensions. The adhesive anchor component further ensures a fixed and reliable connection point for the locking mechanism, while grip-enhancing features provide additional stability. By preventing unwanted lid opening due to environmental forces or animal interference, the device mitigates waste dispersion and supports cleaner surroundings.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trash can lid-securing device. The trash can lid-securing device is an adaptable locking device configured to prevent unauthorized or accidental opening of a trash can lid. The device enhances environmental hygiene by securing the lid to the trash can body, thereby deterring intrusion from wind, animals, or pests and minimizing the spread of litter.

The device is comprised of a body including a vertical frame member and at least two horizontal members. The horizontal members are positioned on opposing ends of the vertical frame member, allowing engagement with both the lid and the body of the trash can to form a locking configuration. The horizontal members are preferably perpendicular to the vertical frame member but may vary in angle or shape.

The vertical frame member may be of fixed or telescopic length. In telescopic embodiments, a locking member is integrated to fix the member at a desired length. The locking member may include mechanisms such as a twist-lock collar, detent pin, ratchet-lock, or threaded compression fitting.

To enable vertical repositioning of horizontal members or other components, the vertical frame member may include a sliding interface, which may comprise a groove, channel, or track. A repositionable member may be integrated into this interface and configured for manual vertical translation using an actuation handle. The repositionable member is preferably compressible and self-locks upon release, allowing adjustment to accommodate varying trash can sizes and lid geometries. In alternative embodiments, one or more horizontal members may be similarly repositionable.

To secure the upper portion of the device to the trash can lid, at least one adhesive anchor is included. The adhesive anchor is mounted to the lid's top surface and includes a receiving point for engaging the top horizontal member. The receiving point may incorporate a dovetail or tab feature that slides into a corresponding receiving area within the horizontal member. The receiving area may include retention features such as ribs, snap locks, or grooves to ensure secure engagement.

The invention is also comprised of a method of use, wherein the device is provided with a vertical frame member, horizontal members, and an adhesive anchor. The vertical frame member is extended to the desired length, the adhesive anchor is affixed to the lid, and the top horizontal member is engaged with the anchor. The bottom horizontal member is then positioned against the trash can body to secure the lid in a closed position.

An alternative method of use includes the use of a repositionable member and/or a repositionable horizontal member. The member is manually adjusted along the sliding interface to align with the trash can geometry. The adhesive anchor is then mounted to the lid, and the corresponding horizontal member is engaged with the receiving point. The opposite horizontal member is secured against the trash can body to lock the lid in place.

Accordingly, the trash can lid-securing device of the present invention is particularly advantageous as it provides a device that secures the lid of a trash can. The inclusion of a telescoping vertical member and/or repositionable components enables adaptability to a variety of receptacle geometries and dimensions. The adhesive anchor component further ensures a fixed and reliable connection point for the locking mechanism, while grip-enhancing features provide additional stability. By preventing unwanted lid opening due to environmental forces or animal interference, the device mitigates waste dispersion and supports cleaner surroundings. In this manner, the trash can lid-securing device overcomes the limitations of existing trash cans known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a trash can lid-securing device of the present invention in accordance with the disclosed architecture;

FIG. 2 illustrates a perspective view of one potential embodiment of a trash can lid-securing device of the present invention while attached to a trash can and a trash can body in accordance with the disclosed architecture;

FIG. 3 illustrates a flowchart of a method of using one potential embodiment of a trash can lid-securing device of the present invention in accordance with the disclosed architecture;

FIG. 4 illustrates a flowchart of a method of using one potential embodiment of a trash can lid-securing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a trash can lid-securing device that prevents wind from opening trash receptacle lids and dispersing waste. There also exists a long-felt need in the art for a trash can lid-securing device that deters small animals from accessing and scattering the contents of trash cans. Moreover, there exists a long-felt need in the art for a trash can lid-securing device that universally adapts to various receptacle sizes and shapes used by different waste management services.

The present invention, in one exemplary embodiment, is comprised of a trash can lid-securing device. The trash can lid-securing device is an adaptable locking mechanism designed to prevent unauthorized or accidental opening of a trash can lid. The device promotes environmental cleanliness by securing the lid to the trash can body, thereby reducing intrusion from wind, animals, or pests and limiting the spread of waste.

The device is comprised of a body including a vertical frame member and at least two horizontal members. The horizontal members are located on opposite ends of the vertical frame member, allowing engagement with both the trash can lid and body to establish a locking arrangement. The horizontal members are preferably positioned perpendicular to the vertical frame member, but may adopt alternative angles or shapes.

The vertical frame member may be constructed with either a fixed or telescopic length. In telescopic configurations, a locking member is integrated to secure the vertical frame member at a selected length. The locking member may employ mechanisms such as a twist-lock collar, detent pin, ratchet-lock, or threaded compression fitting.

To facilitate vertical repositioning of the horizontal members or additional components, the vertical frame member may include a sliding interface, which may take the form of a groove, channel, or track. A repositionable member may be integrated within the interface and configured for manual vertical movement via an actuation handle. The repositionable member is preferably compressible and self-locks upon release, enabling adjustment to fit different trash can heights and lid configurations. In alternate embodiments, one or more horizontal members may also be vertically repositionable in a similar manner.

To attach the upper portion of the device to the trash can lid, at least one adhesive anchor is included. The adhesive anchor is secured to the top surface of the lid and includes a receiving point for engagement with the top horizontal member. The receiving point may feature a dovetail or tab element that inserts into a corresponding receiving area within the horizontal member. The receiving area may incorporate retention elements such as ribs, snap locks, or grooves to maintain engagement.

The invention is further comprised of a method of use, wherein the device is provided with a vertical frame member, horizontal members, and an adhesive anchor. The vertical frame member is extended to the required length, the adhesive anchor is attached to the lid, and the top horizontal member is connected to the anchor. The lower horizontal member is then placed against the trash can body to secure the lid in a closed state.

An alternative method of use involves a repositionable member and/or a repositionable horizontal member. The repositionable component is manually adjusted along the sliding interface to correspond with the trash can geometry. The adhesive anchor is then attached to the lid, and the aligned horizontal member is engaged with the receiving point. The opposite horizontal member is then secured against the trash can body to maintain the lid in a locked position.

As a result, the trash can lid-securing device provides an effective solution for securing a trash can lid. The inclusion of a telescoping vertical member and repositionable elements allows adaptability to various receptacle sizes and shapes. The adhesive anchor ensures a stable connection point for the locking mechanism, and grip-enhancing features offer improved stability. By preventing unintended lid openings due to environmental conditions or animal activity, the device reduces waste spread and contributes to cleaner surroundings. The trash can lid-securing device addresses the shortcomings of existing trash can designs.

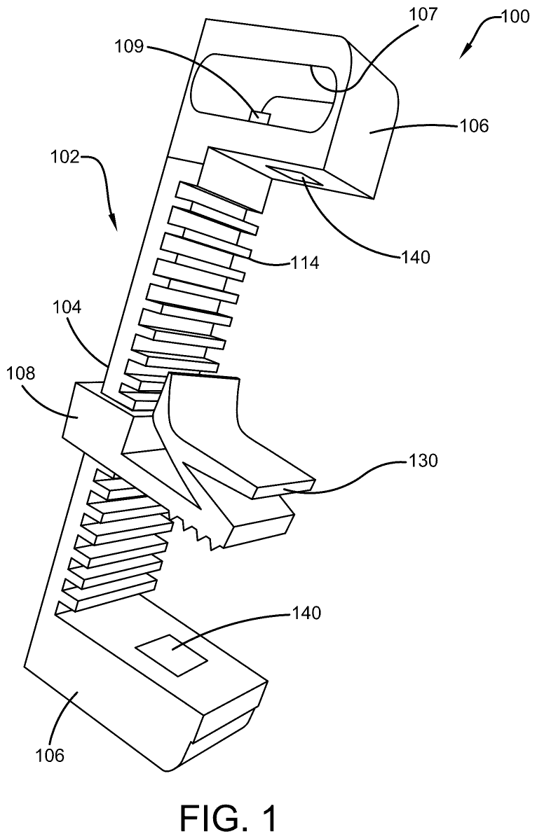

Referring initially to the drawings, FIG. 1 illustrates a perspective view of one potential embodiment of a trash can lid-securing device 100 of the present invention in accordance with the disclosed architecture. The trash can lid-securing device 100 is an adaptable locking device configured to prevent unintended or unauthorized opening of a trash can lid 12. The device 100 is designed to enhance environmental hygiene by securing the lid 12 to the trash can body 10, thereby preventing intrusion by wind, animals, or pests and minimizing litter dispersion.

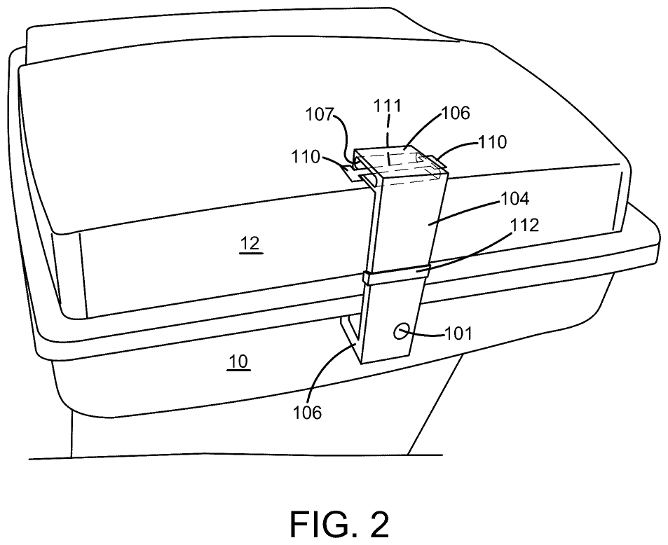

The device 100 is comprised of a body 102. The body 102 includes a vertical frame member 104 and at least two horizontal members 106. The horizontal members 106 are preferably positioned on opposing ends of the vertical frame member 104 (and are preferably parallel), allowing the body 102 to span the height of a typical trash can and engage both the lid 12 and the body 10 in a locking configuration, as seen in FIG. 2. In the preferred embodiment, the horizontal frame members 106 are perpendicular to a vertical axis of the vertical frame member 104, but may be at any angle or shape in different embodiments.

The vertical frame member 104 may be made from durable materials suitable for prolonged outdoor exposure. In preferred embodiments, the vertical frame member 104 and horizontal members 106 are comprised of a corrosion-resistant metal such as anodized aluminum or stainless steel, a high-strength polymer such as polycarbonate or acrylonitrile butadiene styrene (ABS), or a composite material incorporating fiberglass or carbon fiber reinforcements. To resist ultraviolet (UV) degradation caused by sunlight exposure, all structural materials forming the device 100 are preferably UV-resistant, either through inherent material properties or by the inclusion of a UV-stabilizing additive or coating 101.

In one embodiment, the vertical frame member 104 is of fixed length. In another embodiment, the vertical frame member 104 is telescopic, as seen in FIG. 2. In this embodiment, at least one locking member 112 is integrated into the member 104 to lock the member 104 at a desired length. The locking member 112 may comprise a twist-lock collar, spring-loaded detent pin, ratchet-lock mechanism, threaded compression fitting, etc.

To allow the horizontal members 106 and other components to be vertically repositioned in one embodiment, the vertical frame member 104 may include an integrated sliding interface 114, as seen in FIG. 1. The sliding interface 114 may be, but is not limited to, a linear channel, groove, or track that extends along at least a portion of the vertical length of the frame member 104.

In one embodiment, a repositionable member 108 is captured within and is configured to move along the sliding interface 114. Vertical translation of the repositionable member 108 is achieved manually via an actuation handle 130 (as seen in FIG. 1) that can be gripped to slide the member 108 along the sliding interface 114. The member 108 is preferably compressible such that when released by a user, the member 108 self-locks at the current position relative to the interface 114. The adjustability of the repositionable member 108 allows for modification of the vertical spacing between the horizontal members 106 and the member 108, enabling the device 100 to accommodate trash cans of various heights and lid geometries. In a different embodiment, at least one of the horizontal members 106 is repositionable along the vertical member 104 in the same manner.

Each horizontal member 106 may be comprised of a grip structure 140 configured to improve the grip of the device 100 on a trash can lid 12 and body 10. The grip structure 140 may include, but is not limited to, a non-slip material such as thermoplastic elastomer (TPE), a compressible padding layer, or a surface texture pattern such as ridges, dimples, or knurling.

To secure the upper portion of the body 102 to the trash can lid 12, the device 100 is further comprised of at least one adhesive anchor 110. The adhesive anchor 110 is configured to be mounted on the top surface of the trash can lid 12 and acts as a receiver for a portion of the top-most horizontal member 106. In a preferred embodiment, the adhesive anchor 110 includes a receiving point 111 such as, but not limited to, a dovetail or tab feature that slides into a reciprocating receiving area 107 integrated into the horizontal member 106. The receiving area 107 may include retention features 109, such as internal ribs, snap locks, grooves, detents, etc., to secure the engagement.

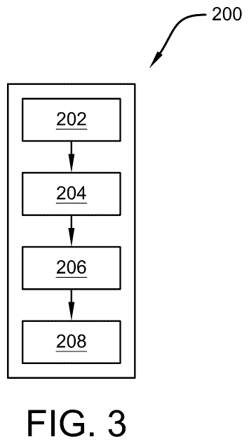

The present invention is also comprised of a method of using 200 the device 100, as seen in FIG. 3. First, a device 100 is provided comprising a body 102 comprising a vertical frame member 104, at least two horizontal members 106, and at least one adhesive anchor 110 [Step 202]. Then, the vertical frame member 104 is extended to a desired length using the telescopic configuration [Step 204]. Next, the adhesive anchor 110 is affixed to a top surface of a trash can lid 12, and the top-most horizontal member 106 is engaged with the adhesive anchor 110 [Step 206]. Finally, the bottom horizontal member 106 is positioned against the body 10 of the trash can to secure the lid 12 in a closed position [Step 208].

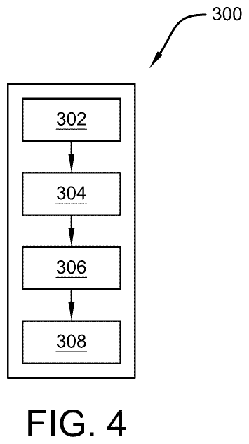

In another embodiment, the present invention is also comprised of a method of using 300 the device 100 with at least one repositionable member 108 and/or repositionable horizontal member 106, as seen in FIG. 4. First, a device 100 is provided comprising a vertical frame member 104 including a sliding interface 114, at least one repositionable member 108, at least two horizontal members 106, and at least one adhesive anchor 110 [Step 302]. Then, the repositionable member 108 and/or repositionable horizontal member 106 is manually translated along the sliding interface 114 to a position that aligns with the geometry of a trash can body 10 and lid 12 [Step 304]. Next, the adhesive anchor 110 is mounted to a top surface of the trash can lid 12, and the corresponding horizontal member 106 is engaged with the receiving point 111 of the adhesive anchor 110 [Step 306]. Finally, the opposite horizontal member 106 is secured against the trash can body 10 to lock the lid 12 in place [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “trash can lid-securing device” and “device” are interchangeable and refer to the trash can lid-securing device 100 of the present invention.

Notwithstanding the foregoing, the trash can lid-securing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trash can lid-securing device 100 as shown in the FIGS. are for illustrative purposes only, and that many other sizes and shapes of the trash can lid-securing device 100 are well within the scope of the present disclosure. Although the dimensions of the trash can lid-securing device 100 are important design parameters for user convenience, the trash can lid-securing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trash can lid-securing device comprising:
a body comprising a telescopic vertical frame member comprised of a locking member, a first horizontal member attached to the telescopic vertical frame member, and a second horizontal member attached to the telescopic vertical frame member; and
an adhesive anchor configured to engage with the first horizontal member to secure a trash can lid in a closed position relative to a trash can body.

2. The trash can lid-securing device of claim 1, wherein the first horizontal member is comprised of a receiving area that receives a receiving point of the adhesive anchor.

3. The trash can lid-securing device of claim 2, wherein the receiving area is comprised of a retention feature comprised of an internal rib, a snap lock, a groove, or a detent.

4. The trash can lid-securing device of claim 1, wherein the locking member is comprised of a twist-lock collar, a spring-loaded detent pin, a ratchet-lock mechanism, or a compression fitting.

5. The trash can lid-securing device of claim 1, wherein the first horizontal member is comprised of a grip structure.

6. The trash can lid-securing device of claim 2, wherein the receiving point is comprised of a dovetail or a tab.

7. The trash can lid-securing device of claim 1, wherein the first horizontal member is parallel to the second horizontal member.

8. The trash can lid-securing device of claim 1 further comprised of a UV-stabilizing additive.

9. A trash can lid-securing device comprising:
a body comprising a vertical frame member comprised of a sliding interface, a first horizontal member attached to the vertical frame member, and a second horizontal member attached to the vertical frame member;
a repositionable member captured within and configured to move vertically along the sliding interface; and
an adhesive anchor configured to engage with the first horizontal member to secure a trash can lid in a closed position relative to a trash can body.

10. The trash can lid-securing device of claim 9, wherein the sliding interface is comprised of a channel.

11. The trash can lid-securing device of claim 9, wherein the sliding interface is comprised of a groove.

12. The trash can lid-securing device of claim 9, wherein the sliding interface is comprised of a track.

13. The trash can lid-securing device of claim 9, wherein the repositionable member is compressible.

14. The trash can lid-securing device of claim 13, wherein the repositionable member is self-locking in an uncompressed state.

15. The trash can lid-securing device of claim 9, wherein the first horizontal member is comprised of a receiving area that receives a receiving point of the adhesive anchor.

16. The trash can lid-securing device of claim 15, wherein the receiving point is comprised of a dovetail or a tab.

17. The trash can lid-securing device of claim 9, wherein the first horizontal member is comprised of a grip structure.

18. The trash can lid-securing device of claim 9, wherein the first horizontal member is parallel to the second horizontal member.

19. The trash can lid-securing device of claim 9 further comprised of a UV-stabilizing additive.

20. A method of using a trash can lid-securing device, the method comprising:
providing a trash can lid-securing device comprised of a vertical frame member comprised of a sliding interface, a repositionable member captured within and configured to move vertically along the sliding interface, a first horizontal member attached to the vertical frame member, a second horizontal member attached to the vertical frame member, and an adhesive anchor;
manually translating the repositionable member along the sliding interface to a position that aligns with a geometry of a trash can body and lid;
mounting the adhesive anchor to a trash can lid;
attaching the adhesive anchor to the first horizontal frame member; and
securing the second horizontal member against the trash can body.
